(19) United States
(12) Patent Application Publication
(10) Pub. No.: US 2003/0007297 A1
(43) Pub. Date: Jan. 9, 2003

(54) Train relief component having an intergrated capacitor

(76) Inventors: Hugo Herrmann, Lauf (DE); Werner Decker, Buehl (DE); Andreas Kuehnpast, Zell Am Harmersbach (DE); Andreas Ewert, Lichtenau (DE); Jens Ulrich, Baden-Baden (DE)

Correspondence Address: Striker Striker & Stenby, 103 East Neck Road, Huntington, NY, 11743, US

(21) Appl. No.: 09/979,412

(22) PCT Filed: Mar. 14, 2001
(86) PCT No.: PCT/DE01/00949

(30) Foreign Application Priority Data
Mar. 23, 2000 (DE) 100 14 474.8

(51) Int. Cl. H02H 7/08

(52) U.S. Cl. 361/23

(57) ABSTRACT

The invention relates to a tension-relief component for electrical leads (14)—particularly of an electric motor—provided with an insulation, having a capacitor (12) for suppression of electromagnetic interference, wherein a contact element (48) is provided that is in electrical contact with the capacitor (12), wherein a contacting of at least one lead (14) takes place in that the contact element (48) penetrates the insulation of the lead (14). The contacting of the lead (14) takes place preferably by means of a mandrel (48). The tension-relief component (10) comprises a retaining clip (26), by means of which the capacitor (12) is secured in the tension-relief component (10), while the mandrel (48) is inserted in the tension-relief component (10). Furthermore, the tension-relief component (10) comprises connecting clips (22) for connection with the leads (14), and mounting clips (24) for connecting with a component (16) of an electric motor connected to ground, so that the tension-relief component (10) can be connected with the leads (14) and with the component (16) connected to ground by clipping into place. The installation of a component for tension relief as well as an interference-suppression capacitor is simplified by means of this construction.

### PRIOR ART

The invention relates to a tension-relief component for leads-in particular of an electric motor-provided with an insulation having a capacitor for suppression of electromagnetic interference, and a contact element is provided that is in electrical contact with the capacitor.

Such a component is made known in DE 34 34 429 A1. Here, the component is a part of an electric motor. The tension-relief function serves to decrease the mechanical load on the points of connection of the electrical leads. To decrease the electromagnetic interferences originating from the electric motor, a capacitor is used that is contacted at the brush holder of the electric motor and at the motor housing, e.g., by clamping between the field frame and the bearing cover. The tension-relief component shown in the cited publication also simultaneously connects electrical leads with separate terminal connections of the electric motor.

A component for the installation of an interference-suppression capacitor is made known in DE 33 14 412 A1 that touches the brush holder of an electric motor on one end and touches the motor housing on the other. On its one end, the component contacts an interference-suppression capacitor connected with the brush holder of the motor.

A disadvantage of the means of attaining the object of the invention described is the expensive installation of the interference-suppression capacitor as well as the component for tension relief.

The object of the invention is to simplify the installation of a component for tension relief as well as an interference-suppression capacitor.

### ADVANTAGES OF THE INVENTION

The component according to the invention having the features of claim 1 offers the advantage that the tension-relief component and the capacitor can be installed in one working step. Since the contacting takes place via a contact element that penetrates the insulation of the lead, there is no need to attach the capacitor to an exposed electrical terminal connection of the lead, so that the terminal of the capacitor must no longer be located in the immediate vicinity of the brush holder, for example. The freedom to position the component for tension relief and to position the capacity is therefore increased.

In an advantageous exemplary embodiment of the invention, the contact element is a mandrel arranged in the tension-relief component. Such a mandrel composed of metal is cost-effective to produce and can be integrated easily in the tension-relief component.

The capacitor advantageously comprises at least one terminal connection that is electrically connected with the mandrel by means of soldering or welding, in order to ensure a reliable electrical contacting.

Preferably, one of the terminal connections of the capacitor is connected to ground. It has been shown that a good interference-suppression effect exists when the capacitor is arranged, for example, between the lead connected to the negative pole and the housing of the motor connected to ground.

In a preferred exemplary embodiment of the invention, the ground contact takes place via a mandrel arranged in the tension relief. Like the contacting of the lead, the contacting of the ground connection can also take place via a mandrel connected with a capacitor terminal connection. This makes the contacting of the motor housing possible even when this is varnished or coated in electrically nonconductive fashion, because the mandrel can penetrate a coating and establish an electrical contact with the metal of the motor housing

In a preferred exemplary embodiment of the invention, the tension-relief component contains a retaining clip, by means of which the capacitor is secured in the capacitor. The mandrel is inserted in the tension-relief component, and the tension-relief component comprises connecting elements for a clipping connection with the leads and with a component of an electric motor connected to ground, so that the tension-relief component can be connected with the leads and the component of the electric motor connected to ground by means of clipping into place. The capacitor can be easily secured in the tension-relief component by means of the retaining clip. Due to this construction, the capacitor and the mandrel can be preinstalled in the tension-relief component, and the subassembly comprised of capacitor, mandrel, and tension-relief component can be installed via machine on the leads and the motor housing. The tension-relief component is preferably composed of plastic and can be produced in an injection-moulding process.

### DIAGRAMS

Further features and advantages of the invention arise from the description of an exemplary embodiment below with reference to the figures attached.

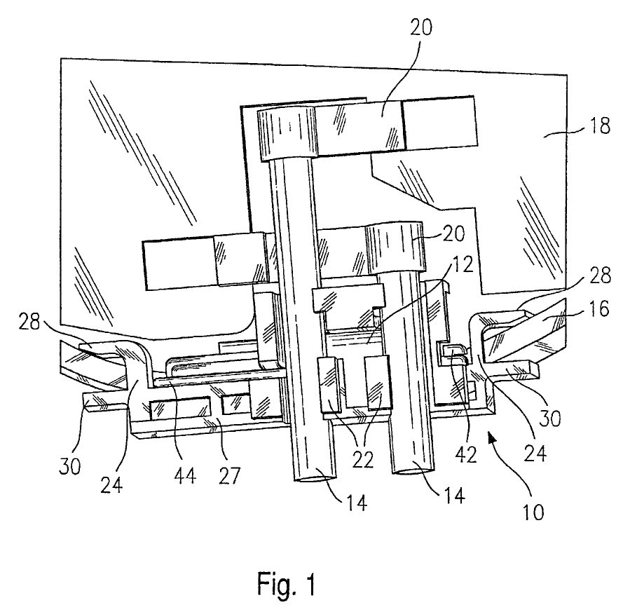

FIG. 1 shows a three-dimensional partial view of a motor housing of an electric motor as well as a tension-relief component according to the invention;

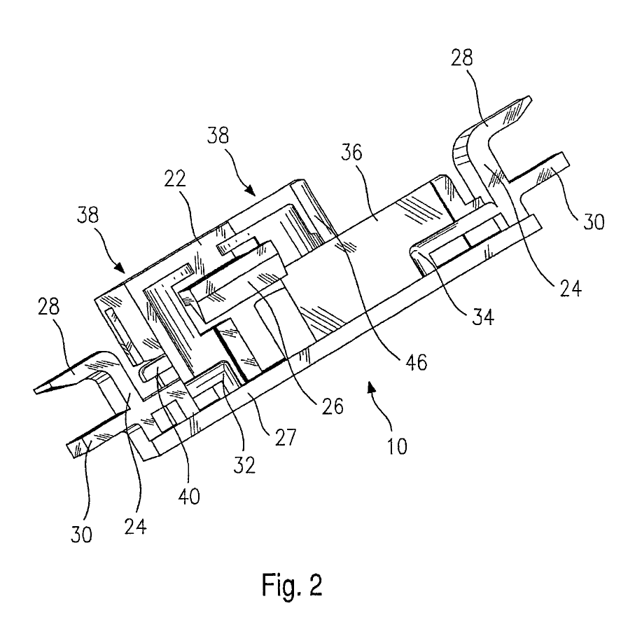

FIG. 2 shows a three-dimensional representation of a tension-relief component according to the invention;

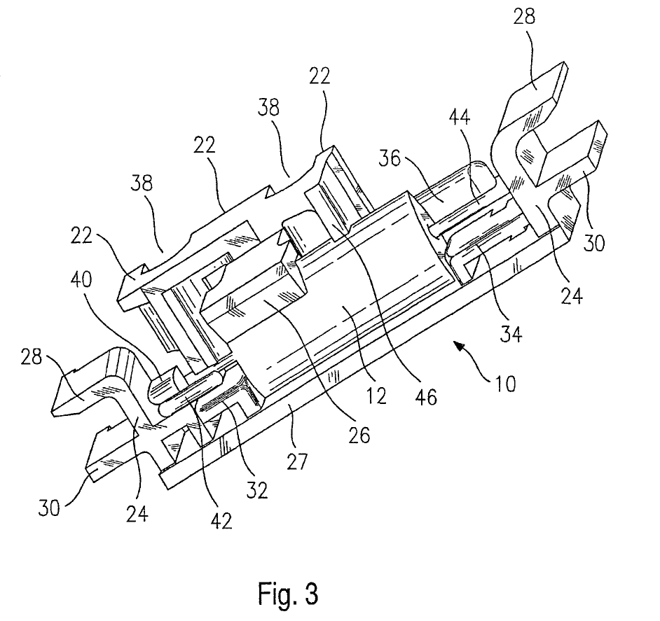

FIG. 3 shows a three-dimensional representation of a tension-relief component according to the invention with installed capacitor;

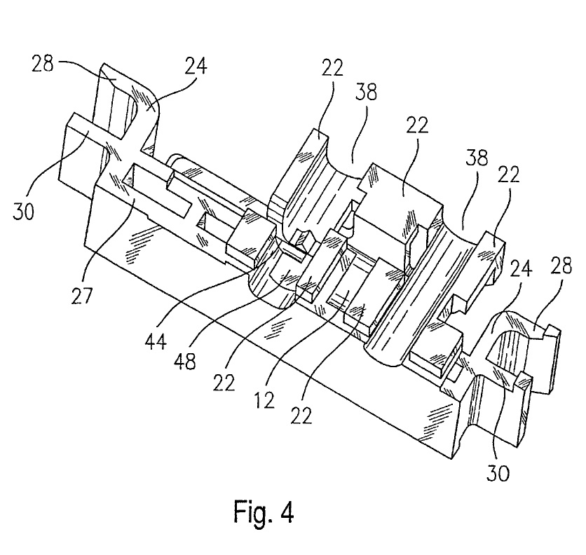

FIG. 4 shows a three-dimensional view of a tension-relief component according to the invention with installed capacitor and installed mandrel;

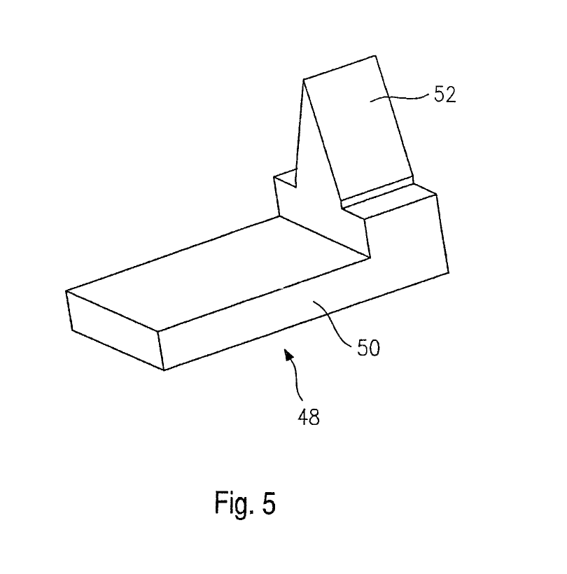

FIG. 5 shows a three-dimensional view of a mandrel for use in a tension-relief component according to the invention;

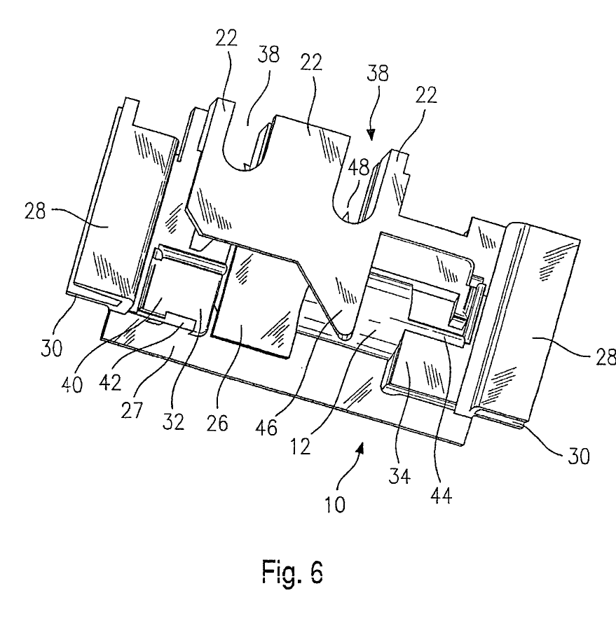

FIG. 6 shows a three-dimensional view of a tension-relief component according to the invention with installed capacitor and installed mandrel; and

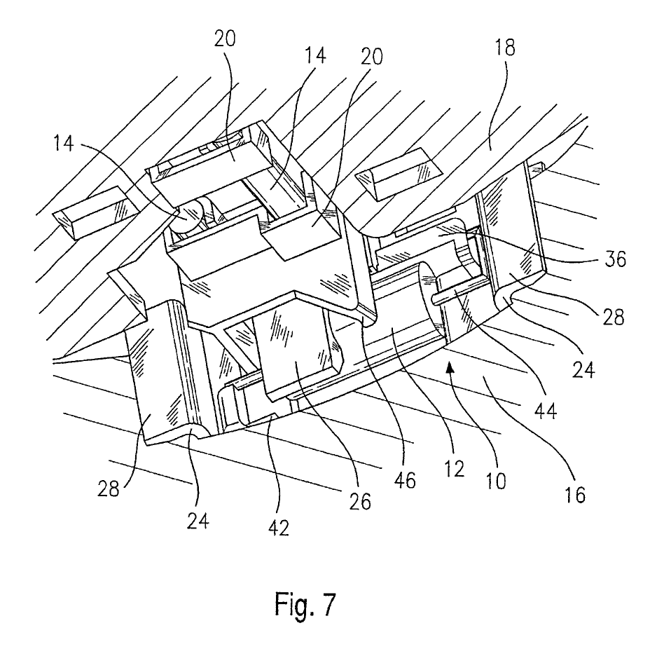

FIG. 7 shows the components presented in FIG. 1 in a three-dimensional view.

### DESCRIPTION OF THE EXEMPLARY EMBODIMENTS

FIG. 1 shows a tension-relief component 10 according to the invention having an installed capacitor 12 in its assembled state, in which the component 10 is mounted between the leads 14 and the field frame 16 of an electric motor. The electrical leads 14 are connected with a brush plate 18 of the motor via connecting elements 20. The view presented in FIG. 1 shows the electric motor from the top and outside.

The tension-relief component comprises connecting clips 22 shown more exactly in FIGS. 3, 4, and 6 for clipping to the leads 14. Two forked mounting clips 24 are located on the outer ends of the component for tension relief 10, by means of which the tension-relief component 10 can be clipped into the field frame 16 of the motor.

FIG. 2 shows the tension-relief component 10 in a three-dimensional view. The tension-relief component 10 contains a base plate 27, on the ends of which the forked mounting clips 24 are arranged. The forked mounting clips 24 comprise an upper bar 28 and a lower bar 30 in each case. Furthermore, two stops 32 and 34 are provided on the base plate 27. The tension-relief component 10 also comprises a wall 36 that extends parallel to the connecting line of the stops 32, 42.

The connecting clips 22 are arranged on the side of the base plate 27 opposite to the stops 32, 34. Recesses 38 are formed in conjunction with the connecting clips 22 that are provided to accommodate the leads 14. Additionally, a retaining clip 26 designed in the shape of a hook is provided for the clipping attachment of the capacitor 12 that extends on the side opposite to the recesses 38. A lug 40 is located on the side of the component for tension relief 10 opposite from the recesses 38.

FIG. 3 shows the tension-relief component 10 with installed capacitor 12 from a similar perspective as FIG. 2. The capacitor 12 is held by a retaining clip 26 designed in the shape of a hook and also by a projection 46 that is arranged next to the retaining clip 26 designed in the shape of a hook, while the stops 32 at both ends of the capacitor 12 prevent the capacitor 12 from moving in the longitudinal direction. The wall 36 prevents the capacitor 12 from moving laterally, so that this is also secured against stress due to shaking in the tension-relief component 10. The terminal connection 42 of the capacitor 12 extends around the lug 40, while the other terminal connection 44 of the capacitor 12 extends around the wall 36 in one of the recesses 38, as also shown in FIG. 6.

FIG. 4 shows the tension-relief component with installed capacitor from the side opposite to the side shown in FIG. 3.

A mandrel 48 is visible in the presentation in FIG. 5 that is inserted in one of the recesses 38. The terminal end 44 of the capacitor bent around the wall 36 is connected with this mandrel 48 in electrically conductive fashion, e.g., by soldering or welding. The mandrel comprises a plate 50 and a tip 52 designed in the shape of a wedge, for example, that is designed as a single piece with the plate 50, as shown in FIG. 5. The mandrel is preferably composed of metal, particularly a non-oxidizing hard metal. The mandrel 48 can be placed in a corresponding recess (not shown) of the recess 38 and cemented there, for example.

FIG. 6 shows a tension-relief component 10 according to the invention with installed capacitor 12 and installed mandrel 48 from above with a view of the base plate 27. The tip 52 of the mandrel 48 is arranged in such a fashion that it projects into the recess 38 in order to penetrate the insulation of the lead 14 when the tension-relief component 10 is clipped to the leads 14.

The tension-relief component 10 according to the invention is installed as follows: First, the terminal connection 44 of the capacitor 12 is connected with the plate 50 of the mandrel 48 by means of soldering or welding, for example. Then, the mandrel 48 is inserted into one of the recesses 38, and the capacitor is clipped into place between the stops 32 and 34 under the retaining clip designed in the shape of a hook, and under the projection 46. The terminal connection 44 of the capacitor 12 is thereby bent around the wall 36 and, as mentioned, extends to the mandrel 48 in the recess 38. The other terminal connection 42 of the capacitor extends around the lug 40 and extends parallel to the bars 28, 30 of the forked installation clips 24 on the side of the component for tension relief 10 opposite to the recesses 38.

The preassembled subassembly composed of tension-relief component 10, capacitor 12, and mandrel 48 is then fitted on the leads 14 in such a fashion that the leads 14 are accommodated in the recesses 38. The connecting clips 22 thereby prevent the leads 14 from sliding out of the recesses 38. When the leads 14 are inserted in the recesses 38, the tip 52 of the mandrel 48 penetrates the insulation of one of the leads 14 and thereby establishes an electrical contact between the lead 14 and the capacitor 12.

The forked mounting clips 24 are fitted on the field frame 16 in such a fashion that upper bar 28 and the lower bar 30 of each of the forked mounting clips 24 enclose the wall of the field frame. As a result—as shown in FIG. 7—the terminal connection 42 of the capacitor 12 comes in contact with the field frame 16 of the electric motor. The terminal connection 42 of the capacitor 12 is therefore connected to ground.

The contacting of the field frame of the electric motor can also take place by means of a further mandrel applied to the ground connection of the capacitor, so that a contacting of the motor housing is also possible when this is varnished or coated in non-conductive fashion, for example.

As an alternative to the installation presented above, the following procedure is also possible: The preassembled subassembly is first fitted onto the field frame 16. The terminal connection 42 of the capacitor 12 is then brought in contact with the field frame 16. Finally, the leads 14 are placed in the recesses 38, so that the tip 52 penetrates the insulation of the lead.

The tension-relief component and the interference-suppression capacitor 12 are easy to install because no bolted joints are required. Installation can also take place via machine in that, for instance, the preassembled tension-relief component 10 with the capacitor 12 and the mandrel 48 are fed in a shaker during production and automatically installed.

The tension-relief component 10 is preferably composed of plastic and can be produced using an injection-moulding process. Due to its construction, the tension-relief component 10 shown in FIG. 2 can be released from the moulding die without lateral slides, which leads to lower manufacturing costs.

Since only one new part must be fabricated, the tension-relief component is also easy to install in existing motors.

### LIST OF REFERENCE NUMBERS

10 Tension-relief component

12 Capacitor

14 Leads

16 Field frame

18 Brush plate

20 Connecting element

22 Connecting clip

24 Mounting clip

26 Retaining clip

27 Base plate

28 Upper bar

30 Lower bar

32 Stop

34 Stop

36 Wall

38 Recess

40 Lug

42 Ground terminal connection

44 Lead terminal connection

46 Projection

48 Mandrel

50 Plate

52 Tip

1. Tension-relief component for electrical leads (14)—in particular of an electric motor—provided with an insulation, having a capacitor (12) for suppression of electromagnetic interference, wherein a contact element (48) is provided that is in electrical contact with the capacitor (12), characterized in that a contacting of at least one lead (14) takes place in that the contact element (48) penetrates the insulation of the lead (14).

2. Tension-relief component according to claim 1, characterized in that the contact element is a mandrel (48) arranged in the tension-relief component.

3. Tension-relief component according to one of the claims 1 and 2, characterized in that the capacitor (12) comprises at least one terminal connection (44) that is electrically connected with the mandrel (48) by means of soldering or welding.

4. Tension-relief component according to one of the preceding claims, characterized in that one of the terminal connections (42) of the capacitor is connected to ground.

5. Tension-relief component according to claim 4, characterized in that the contacting with ground takes place via a further mandrel arranged in the tension-relief component (10).

6. Tension-relief component according to one of the claims 1 through 3, characterized in that one of the terminal connections (42) of the capacitor is connected with the motor housing.

7. Tension-relief component according to one of the preceding claims, characterized in that the tension-relief component (10) comprises a retaining clip (26), by means of which the capacitor (12) is secured in the tension-relief component (10), that the mandrel (48) is inserted in the tension-relief component (10), and that the tension-relief component (10) comprises connecting clips (22) for connection with the leads (14) and mounting clips (24) for connection with a component (16) of an electric motor connected to ground, so that the tension-relief component (10) can be connected with the leads (14) and the component (16) can be connected to ground by means of clipping into place.
